(19) United States
(12) Patent Application Publication
(10) Pub. No.: US 2013/0340421 A1
(43) Pub. Date: Dec. 26, 2013

(54) DEVICE FOR TRANSFERRING A HYDRAULIC WORKING PRESSURE IN A PRESSURE FLUID FOR ACTUATING HYDRAULIC UNITS OF DEEP-SEA SYSTEMS

(71) Applicants: Martin Groben, Sulzbach (DE); Elmar Betzler, Igel (DE)

(72) Inventors: Martin Groben, Sulzbach (DE); Elmar Betzler, Igel (DE)

(73) Assignee: Hydac Technology GmbH

(21) Appl. No.: 13/261,696

(22) PCT Filed: Jan. 17, 2012
(86) PCT No.: PCT/EP2012/000166

§ 371 Date: Sep. 4, 2013

(30) Foreign Application Priority Data
Jan. 25, 2011 (DE) 10 2011 009 276.5

(51) Int. Cl. F15B 15/00

(52) U.S. Cl. CPC F15B 15/00
USPC 60/413

(57) ABSTRACT

The invention relates to a device for transferring a hydraulic working pressure in a pressure fluid for pressure actuating hydraulic units of deep sea systems, in particular deepwater wells, wherein a first pressure chamber (19) for the pressure fluid, a displaceable piston arrangement (9, 11, 13) for changing the volume of said pressure chamber (19), and at least one second pressure chamber (21) are present in a cylinder arrangement (1), wherein the surrounding pressure of the deep sea can be applied to the second pressure chamber for a displacement of the piston arrangement (9, 11, 13) generating the working pressure in the first pressure chamber (19), characterized in that a pressure accumulator (37) is associated with the cylinder arrangement (1), the displaceable separating element (41) of said pressure accumulator separating a chamber (45) connected to the seawater from an actuating chamber (43), which contains an actuating fluid and is connected to the second pressure chamber (21) in order to apply the deep sea pressure to said second pressure chamber by means of the actuating fluid.

The invention relates to a device for transferring a hydraulic working pressure in a pressure fluid for actuating hydraulic units of deep-sea systems, in particular deep water wells, wherein a first pressure chamber for the pressure fluid, a displaceable piston arrangement for changing the volume of said pressure chamber, and at least one second pressure chamber are present in a cylinder arrangement, wherein the surrounding pressure of the deep sea can be applied to the second pressure chamber for displacing the piston arrangement in order to generate the working pressure in the first pressure chamber.

An ever increasing scarcity of resources demands ever greater efforts for obtaining raw materials and sources of energy. As a result, drilling for oil and gas is conducted at ever greater ocean depths. To ensure the safety of such deep-sea drilling operations, which are implemented from drilling platforms or ships, comprehensive safety installations are provided on the ocean floor that are functionally allocated to the transitional area between the drill hole and drill pipe or delivery pipe. One important system part of the safety standard of such deep-sea drilling applications is the so-called “blow-out preventer” (BOP), which is a device that causes a quick-closure of the outlet to the drill hole and/or drill pipe and/or delivery pipe, should a hazardous situation occur. To ensure safe functioning thereof, pressure fluid at a correspondingly high working pressure must be reliably provided for the hydraulic actuation.

To avoid the difficulties that must be overcome to convey a pressure fluid that has a sufficiently high working pressure and that is available in a sufficient quantity from a drilling platform or ship on the water's surface to the ocean floor, located correspondingly at a great depth, the prior art (see U.S. Pat. No. 6,418,970 B1) discloses a device of the kind as mentioned in the introduction for providing the hydraulic working pressure that is required for actuating the related deep-sea system in situ, meaning that the necessary hydraulic working pressure is generated by utilizing the surrounding pressure of the deep sea, which is the high deep water pressure, specifically in that the surrounding deep water pressure of the deep sea is applied to a piston apparatus inside a cylinder arrangement, and the hydraulic pressure is generated by the thus achieved movement of the piston inside a pressure chamber of the cylinder arrangement.

Despite the advantages that are created due to the generation or in situ transfer of the working pressure, the operating properties of the known device are not satisfactory. The use of seawater for operating the cylinder arrangement poses problems in several regards. On the one hand, there exists a contamination risk due to the penetration of sediment particles and the like, or of microorganisms that are introduced together with the seawater. On the other hand, the system is compromised due to the extremely corrosive effect of the seawater. To counteract the last mentioned problem, the cylinder arrangement must be suitably lined with, and/or manufactured from, correspondingly corrosion-proof materials to reduce corrosion and/or the elevated friction coefficient with the piston movements due to deposits. Despite these measures, difficulties persist, due to salt water deposits, for example calcium stearate.

On the basis of this set of problems, it is the underlying object of the present invention to provide a device of the type specified that ensures improved operating reliability, while preserving the advantages that are realized from the in situ pressure transfer.

According to the invention, this object is achieved with a device that has all the characteristics as set forth in Claim 1.

A substantial special aspect of the invention is provided accordingly in that, contrary to the prior art, the working pressure inside the cylinder arrangement is not generated or transferred by seawater acting directly on the piston arrangement; instead, a pressure accumulator is disposed upstream of the cylinder arrangement, from which an actuating fluid, subject to the deep-sea pressure, can be supplied to the cylinder arrangement. To this end, the pressure accumulator includes a chamber that is in communication with the seawater and that is separated from the chamber containing the actuation fluid by a displaceable separating element, and which is in communication with the corresponding pressure chamber of the cylinder arrangement in order to apply the deep-sea pressure to the same by means of the actuating fluid, thereby affecting the displacement of the piston and generating the working pressure. In contrast to the prior art, only one chamber is, therefore, in communication with the seawater that is loaded with the corrosive and possibly problematic materials, while, due to the pressure accumulator that is disposed upstream of the cylinder arrangement, the cylinder arrangement proper is separated from the seawater but is, nevertheless subjected to deep-sea pressure applied thereto because the displaceable separating element of the pressure accumulator preloads the actuating fluid with the respectively present deep-sea pressure.

Advantageously, the pressure accumulator can include a separating element that is able to tolerate the effects of seawater, wherein the parts of the pressure accumulator that are disposed upstream and that come in contact with salt water are made of a non-corrosive steel or have a protective coating.

Especially advantageously, a bladder accumulator or a hydro accumulator is provided, equipped with a bladder that is made, for example, of a plastic of synthetic rubber material.

It is especially advantageous to provide a mixture of water and glycol as actuating fluid in the pressure accumulator. Such a fluid prevents corrosion, reduces friction in the manner of a lubricant and offers, simultaneously, an antifreeze effect that precludes any hazards due to icing, which can occur due to cooling in connection with expansion processes.

If the cylinder arrangement is provided in the form of a dual piston accumulator, the apparatus can advantageously include two cylinder parts per piston, respectively, which are coaxially disposed relative to each other and separated from each other by a separating body that is disposed there-between, and the same are connected to each other by a piston rod that is routed in a sealed fashion through the separating body and each of which are adjacent on both sides relative to a pressure chamber, and the first and the second pressure chamber of which are disposed, respectively, between the separating body and the one and the other piston.

Moreover, between the piston delimiting the first pressure chamber and the closed end of the related cylinder part, it is possible to provide a preload pressure chamber for pressurized gas, such as N₂. When operating the device, the deep-sea pressure as well as, simultaneously, the preload pressure acting upon the piston arrangement are available for actuating the device.

To allow for virtually unhindered piston displacement in order to generate the working pressure when the cylinder arrangement is sealed, a low-pressure pressure chamber is preferably disposed between the piston delimiting the second pressure chamber and the closed end of the related cylinder part for a gas, intended for minimally pressurized gas, preferably provided by a vacuum pressure, such as N₂.

A pressure container for the gas, that is pressurized with a preload pressure, is connected in especially preferred embodiments to the preload pressure chamber. This way, aside from the gas volume in the preload pressure chamber, the gas volume of the additional pressure container is available for the cylinder arrangement, which supports the piston displacement that occurs for the generation of the working pressure over the entire stroke of the piston.

The pressure container can be constituted of a cylindrical pipe body that is disposed parallel to and adjacent to the cylinder parts of the cylinder arrangement. The diameter of the pipe body therein is, preferably, greater than the cylindrical diameter of the cylinder arrangement, such that a relatively large extra gas volume of gas, which is preload-pressurized, is available.

Advantageously, a line can be formed in the end piece, located at the closed end of the preload pressure chamber, that connects, via a bore, respectively, in the associated closed end of the pipe body and in the closed end of the preload pressure chamber, the same to the pressure container.

With regard to the construction of the diaphragm accumulator, advantageously, the apparatus can be configured such that the bladder accumulator or hydro accumulator has an accumulator housing in the form of an oblong accumulator cylinder that is disposed parallel to and adjacent to the cylinder arrangement, and that extends along the total length of the cylinder part that contains the second pressure chamber.

The invention will be illustrated below in further detail based on an embodiment as depicted in the drawings.

Shown are as follows:

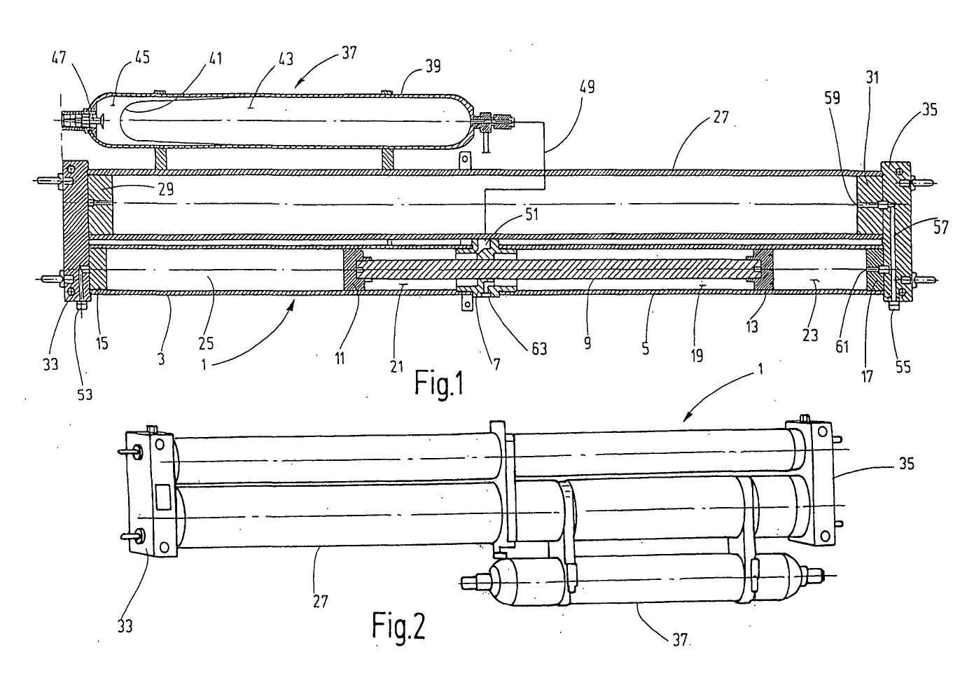

FIG. 1 shows a schematically drawn simplified longitudinal section of an embodiment of the device according to the invention; and

FIG. 2 shows a perspective representation of the embodiment, also drawn in a simplified manner.

The embodiment of the device according to the invention that is depicted in the drawing is intended for use in connection with a so-called “blow-out preventer”(BOP) that is disposed as a safety installation for a deep water well at great ocean depths of, for example, 3,600 meters. In applications of this kind, the device can have a considerable construction size. The cylinder arrangement that constitutes the main part of the device, which is designated in the drawing by the numeral 1, can, for example, have a length in the range of 4 meters. The cylinder arrangement 1 is designed as a dual piston accumulator, having a first cylinder part 3 and a second cylinder part 5 that are coaxially disposed relative to each other and connected to each other via a separating body 7 that seals a first cylinder part 3 and a second cylinder part 5 from each other. Extending through the separating body 7 is a piston rod 9 that has, on one end thereof, a piston 11 attached thereto, which is displaceable in the first cylinder part 3, and a piston 13, which is displaceable in the second cylinder part 5. The piston rod 9 is routed through the separating body 7 in a sealed fashion. On the end thereof, the cylinder part 3 is closed off by a closure part 15, and the cylinder part 5 is closed off by a closure part 17.

With this construction, the cylinder arrangement 1 defines four interior pressure chambers; namely, a first pressure chamber 19 containing the pressure fluid, that is provided for actuating the BOP, disposed between the separating body 7 and the piston 13 that is disposed in the second cylinder part 5. A second pressure chamber 21, which is disposed between the separating body 7 and the piston 11 disposed in the first cylinder part 3, is provided for the actuating fluid that causes the piston displacement by means of the actuating pressure, which is generated by the surrounding pressure of the deep sea, in order to transfer the working pressure in the first pressure chamber 19. Moreover, a preload pressure chamber 23 is disposed as a third pressure chamber between the closure part 17 of the second cylinder part 5 and the allocated piston 13, and a low-pressure chamber 25 that is disposed between the closure part 15 of the first cylinder part 3 and the allocated piston 11 is disposed therein as a fourth pressure chamber.

As shown by the figures, parallel next to, and closely adjacent to the cylinder arrangement 1, there is a pressure container 27 in the form of a cylindrical pipe body that has the same length as the cylinder arrangement 1 but a larger diameter, which is, preferably, double the diameter of the cylinder arrangement. On the end thereof, the pressure container 27 is closed off by closure parts 29 and 31. The closed ends of the cylinder parts 3 and 5, which are aligned flush, relative to each other, as well as the pressure container 27, meaning the respective closure parts 15 and 29, as well as 17 and 31, are connected to each other, respectively, by means of an end piece 33 and 35, respectively. The pressure container chamber 27 is connected, furthermore, to the preload chamber 23 by means of the end piece 35.

The device completes a corrosion-proof pressure accumulator 37, in the embodiment in the form of a bladder accumulator or hydro accumulator, having an oblong plastic-coated accumulator housing 39 that extends along the pressure container 27, parallel to, and adjacent to the same, having a length that corresponds approximately the length of the adjacent first cylinder part 3. The bladder or diaphragm 41 that is disposed inside the pressure accumulator 27 as a separating element is made of a material that is able to tolerate seawater, for example a plastic or elastomer material, dividing the interior space of the pressure accumulator 37 into an actuating chamber 43 and a seawater chamber 45 that is in communication with the surrounding seawater via a check valve 47 that allows water to enter and operates in the manner of a disc valve. The actuating chamber 43 is connected to an actuating input 51 via a pressure line 49 that is in communication with the first pressure chamber 21 via a channel in the separating body 7 of the cylinder arrangement 1.

For operating the device, a low gas pressure, preferably vacuum pressure, is generated in a gas filling (N₂) of the low-pressure pressure chamber 25 via connection 53. The accumulator is filled with a mixture of water and glycol, to be used as an actuating fluid that is inside the actuating chamber 43 of the bladder accumulator or hydro accumulator 37. At a water depth of, for example, 3,600 meters and a water pressure of 360 bar in the seawater chamber 45 of the pressure accumulator 37, the first pressure chamber 21 is then preloaded via the line 49 originating from the pressure accumulator 37 and by means of the actuating fluid until an actuation pressure of 360 bar is reached. Via a preload connection 55 on the end piece 35, which connects the closure parts 17 and 31 to the cylinder part 5 and the pressure container 27, as well as via lines 57 in the end piece 35 and bore holes 59 and 61 in the closure parts 31 and 17, respectively, the pressure accumulator 27, and thereby the preload pressure chamber 23 of the cylinder arrangement 1, are filled with a (N₂) gas at a preload pressure. At a preload pressure in the range of 280 bar in the preload pressure chamber 23, the seawater pressure in the second pressure chamber 21 of, for example, 360 bar (3,600 m water depth) and a vacuum pressure in the low-pressure pressure chamber 25, a pressure level of considerably more than 600 bar is thus available for the displacement motion by the pistons 11, 13, in FIG. 1 toward the left, in order to provide the working pressure in the hydraulic fluid contained in the first pressure chamber, which is thus also provided at the working output 63 of the separating body 7. Due to the comparatively large volume of the preload gas that is available, due to the reserve volume inside the pressure container 27, the entire stroke path of the piston can be traversed, supported by the preload pressure. Correspondingly, the functioning of the device according to the invention is not only particularly reliable in terms of operation because, due to the pressure accumulator 37, the seawater is separated from the cylinder arrangement 1, but the hydraulic working pressure is generated with special efficiency, due to the reserve volume of the preload gas pressure available in the pressure container 27.

1. A device for transferring a hydraulic working pressure in a pressure fluid for pressure-actuating hydraulic units of deep-sea systems, in particular deep water wells, wherein a first pressure chamber (19) for the pressure fluid, a displaceable piston arrangement (9, 11, 13) for changing the volume of said pressure chamber (19), and at least one second pressure chamber (21) are present in a cylinder arrangement (1), wherein the surrounding pressure of the deep sea can be applied to the second pressure chamber for a displacement of the piston arrangement (9,11, 13) generating the working pressure in the first pressure chamber, characterized in that a pressure accumulator (37) is associated with the cylinder arrangement (1), the displaceable separating element (41) of said pressure accumulator separating a chamber (45) that is in communication with the seawater from an actuating chamber (43), which contains an actuating fluid and is connected to the second pressure chamber (21) in order to apply the deep-sea pressure to said second chamber by means of the actuating fluid.

2. The device according to claim 1, characterized in that the pressure accumulator (37) includes a separating element (41) that is able to tolerate the effects of seawater.

3. The device according to claim 1, characterized in that a pressure accumulator is provided in the form of a bladder accumulator of hydro accumulator (37).

4. The device according to claim 1, characterized in that a mixture of water and glycol is provided as actuating fluid in the pressure accumulator (37).

5. The device according to claim 1, characterized in that a cylinder arrangement is provided in the form of a dual piston accumulator (1).

6. The device according to claim 1, characterized in that the cylinder arrangement (1) includes two cylinder parts (3, 5) that are coaxially disposed relative to each other and separated from each other by a separating body (7) disposed there-between for one piston (11, 13) each, that are connected to each other via a piston rod (9), which is routed in a sealed fashion through the separating body (7) and each of which are adjacent on both sides thereof to a pressure chamber (19, 21) of which the first (19) and the second pressure chamber (21) are disposed, respectively, between the separating body (7) and the one (13) and the other piston (11).

7. The device according to claim 1, characterized in that a preload pressure chamber (23) for a gas, such as N2, that is under a pressurized preload, is disposed between the piston (13) that delimits the first pressure chamber (19) and the closed end (17) of the related cylinder part (5).

8. The device according to claim 1, characterized in that a low-pressure pressure chamber (25) for a gas, such as N2, that is pressurized to a low pressure level, preferably vacuum pressure, is disposed between the piston (11) that delimits the second pressure chamber (21) and the closed end(15) of the related cylinder part (3).

9. The device according to claim 1, characterized in that a pressure container (27) that is connected to the preload pressure chamber (23) is available for the gas that is pressurized to preload pressure.

10. The device according to claim 1, characterized in that the pressure container is constituted of a cylindrical pipe body (27) that is disposed parallel to, and closely adjacent to, the cylinder parts (3, 5) of the cylinder arrangement (1).

11. The device according to claim 1, characterized in that the pipe body (27) extends over the entire length of the cylinder arrangement (1), and in that the closed ends (15, 17) of the cylinder parts (3, 5) of the cylinder arrangement (1), which are aligned flush relative to each other, and the pipe body (27) are connected, respectively, via an end piece (33, 35).

12. The device according to claim 1, characterized in that a line (57) is formed in the end piece (35), which is disposed at the closed end (17) of the preload pressure chamber (23) connecting the same to the pressure container (27), via one bore hole (59, 61) in the associated closed ends (31) of the pipe body (27) and in the closed end (17) of the preload pressure chamber (23), respectively.

13. The device according to claim 1, characterized in that the bladder accumulator or hydro accumulator (37) has a corrosion-proof accumulator housing (39) in the form of an oblong accumulator cylinder that is disposed parallel to and adjacent to the cylinder arrangement (1), and that extends along the cylinder part (3) containing the second pressure chamber (21) over the total length thereof.
